(19) United States
(12) Patent Application Publication
(10) Pub. No.: US 2022/0169132 A1
(43) Pub. Date: Jun. 2, 2022

(54) CONTROL DEVICE, CONTROL SYSTEM, AND COMPUTER READABLE RECORDING MEDIUM

(71) Applicant: TOYOTA JIDOSHA KABUSHIKI KAISHA, Aichi-ken (JP)

(72) Inventors: Shogo TSUGE, Fuji-shi (JP); Kengo HACHIYA, Susono-shi (JP); Kyoko ITOH, Susono-shi (JP); Hitoshi HIBINO, Susono-shi (JP); Hiroya CHIBA, Susono-shi (JP)

(21) Appl. No.: 17/533,114

(22) Filed: Nov. 23, 2021

(30) Foreign Application Priority Data
Dec. 1, 2020 (JP) 2020-199872

(51) Int. Cl. B60L 53/22; B60L 53/16; B60L 53/18; B60W 20/20

(52) U.S. Cl. CPC B60L 53/22; B60W 20/20; B60L 53/18; B60L 53/16

(57) ABSTRACT

A control device includes a processor configured to: acquire a remaining capacity of a mobile terminal; and control a charger configured to charge the mobile terminal to charge the mobile terminal in a case where the remaining capacity of the mobile terminal is equal to or less than a predetermined value.

The present application claims priority to and incorporates by reference the entire contents of Japanese Patent Application No. 2020-199872 filed in Japan on Dec. 1, 2020.

### BACKGROUND

The present disclosure relates to a control device, a control system, and a computer readable recording medium.

There is known a vehicle including a non-contact charger that performs non-contact charging from a power supply device.

### SUMMARY

There is a need for a control device, a control system, and a computer readable recording medium that are able to prevent insufficient charging of a mobile terminal.

According to one aspect of the present disclosure, there is provided a control device including a processor configured to: acquire a remaining capacity of a mobile terminal; and control a charger configured to charge the mobile terminal to charge the mobile terminal in a case where the remaining capacity of the mobile terminal is equal to or less than a predetermined value.

### BRIEF DESCRIPTION OF THE DRAWINGS

FIG. 1 is a diagram schematically illustrating a configuration of a charging system including a control device according to an embodiment;

FIG. 2 is a block diagram illustrating details of the control device according to the embodiment;

FIG. 3 is a block diagram illustrating details of a mobile terminal; and

FIG. 4 is a block diagram illustrating details of a server.

### DETAILED DESCRIPTION

A control device, a control system, and a computer readable recording medium storing a program according to an embodiment of the present disclosure will be described with reference to the drawings. Note that components in the following embodiment include those that may be easily replaced by those skilled in the art or those that are substantially the same.

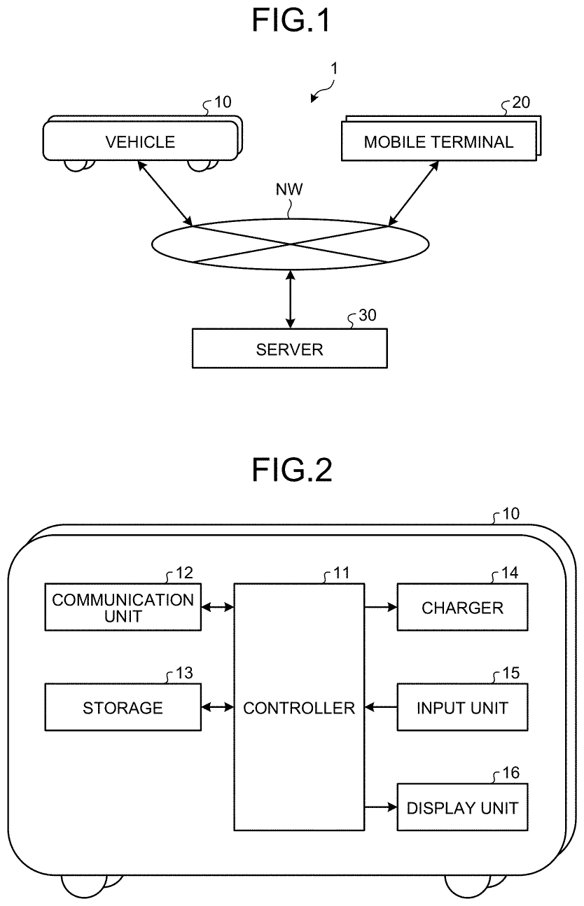

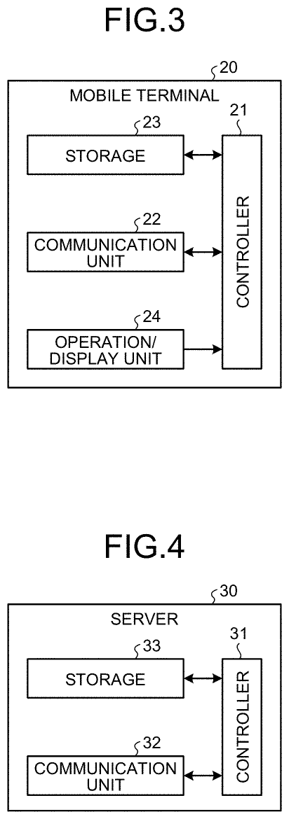

A configuration of a charging system including a moving body according to the embodiment will be described with reference to FIGS. 1 to 4. As illustrated in FIG. 1, a charging system 1 includes a vehicle 10 as the moving body, a mobile terminal 20, and a server 30.

The vehicle 10, the mobile terminal 20, and the server 30 are configured to be able to communicate with each other through a network NW. The network NW is, for example, a public communication network such as the Internet, and may include another communication network such as a wide area network (WAN), a telephone communication network for a mobile phone or the like, or a wireless communication network such as WiFi (registered trademark).

The vehicle 10 is a vehicle that is driven by a driver for traveling or an autonomous traveling vehicle configured to be able to autonomously travel in accordance with a given travel command. As illustrated in FIG. 2, the vehicle 10 includes a controller (processor) 11 as the control device, a communication unit 12, a storage 13, a charger 14, an input unit 15, and a display unit (display) 16. Furthermore, in the following description, the vehicle 10 will be described as an example of the moving body, but the moving body is not limited to the vehicle 10, and may be a bus, a taxi, a drone, an airplane, a ship, or the like.

Specifically, the controller 11 includes a processor including a central processing unit (CPU), a digital signal processor (DSP), a field-programmable gate array (FPGA), and the like, and a memory (main storage) including a random access memory (RAM), a read only memory (ROM), and the like.

The controller 11 loads a program stored in the storage 13 into a work area of the main storage, executes the program, and controls each component or the like through the execution of the program, thereby implementing a function matching a predetermined purpose. Specifically, the controller 11 acquires a remaining capacity of the mobile terminal 20 from the communication unit 12, and causes the charger 14 to charge the mobile terminal in a case where the remaining capacity of the mobile terminal 20 is equal to or less than a predetermined value. For example, the controller 11 generates and outputs information for displaying, on the display unit 16, the fact that the mobile terminal 20 may be charged by the charger 14, thereby leading a user to charge the mobile terminal with the charger 14.

The communication unit 12 includes, for example, a local area network (LAN) interface board, a wireless communication circuit for wireless communication, and the like. The communication unit 12 is connected to the network NW such as the Internet, which is a public communication network. In addition, the communication unit 12 communicates with the mobile terminal 20 and the server 30 by being connected to the network NW. Furthermore, the communication unit 12 has a communication function conforming to a standard such as Near field radio communication (NFC), Bluetooth (registered trademark) Low Energy (BLE), or Infrared Data Association (IrDA), and may communicate with a communication unit 22 directly. Specifically, the communication unit 12 acquires the remaining capacity of the mobile terminal 20 from the mobile terminal 20 under the control of the controller 11.

The storage 13 includes a recording medium such as an erasable programmable ROM (EPROM), a hard disk drive (HDD), or a removable medium. Examples of the removable medium include a recording medium such as an optical disk (compact disc recordable (CD-R), CD-ROM, digital versatile disc recordable (DVD-R), DVD-ROM, Blu-ray (registered trademark) disc (BD), or the like) and a flash memory (universal serial bus (USB) memory, memory card, or the like), for example. The storage 13 may store an operating system (OS), various programs, various tables, various databases, and the like.

The charger 14 may charge the mobile terminal carried by the user who gets in the vehicle 10. The charger 14 may be a contact charger to which the mobile terminal 20 is connected, or may be a non-contact charger that charges the mobile terminal 20 in a non-contact manner.

The input unit 15 includes an input device such as a touch panel superposed on the display unit 16, voice input by a microphone, a keyboard, or a switch, receives input by a finger, voice, or the like of an occupant of the vehicle 10, and outputs a signal corresponding to the input to the controller 11.

The display unit 16 displays an image under the control of the controller 11. The display unit 16 is, for example, a display device such as a liquid crystal display (LCD) or an organic electroluminescent display (OELD), and may be a display unit of a car navigation system. The display unit 16 displays, for example, the fact that the mobile terminal 20 may be charged by the charger 14.

The mobile terminal 20 is a portable computer terminal used by the user. Examples of the mobile terminal 20 include a smartphone, a mobile phone, a tablet terminal, a wearable computer, a personal computer, a car navigation device, a game machine, and the like owned by the user. The mobile terminal 20 may be any terminal as long as information may be exchanged with the vehicle 10.

The mobile terminal 20 includes a controller (processor) 21, the communication unit 22, a storage 23, and an operation/display unit (display) 24. The controller 21, the communication unit 22, the storage 23, and the operation/display unit 24 are physically similar to the controller 11, the communication unit 12, the storage 13, the input unit 15, and the display unit 16.

The controller 21 acquires a remaining capacity of a secondary battery such as a battery and outputs the remaining capacity from the communication unit 22.

The communication unit 22 communicates with the communication unit 12 via the network NW or directly.

The operation/display unit 24 includes, for example, a touch panel display, and has an input function of receiving an operation by a finger of the user, a pen, or the like, and a display function of displaying various types of information under the control of the controller 21.

The server 30 is a server that comprehensively manages information regarding a plurality of vehicles including the vehicle 10 or information regarding a plurality of mobile terminals including the mobile terminal 20, and is provided, for example, in a management center that manages the vehicles or the mobile terminals. The server 30 includes a controller (processor) 31, a communication unit 32, and a storage 33. The controller 31, the communication unit 32, and the storage 33 are physically similar to the controller 11, the communication unit 12, and the storage 13.

Next, a method will be described in which the vehicle 10 according to the embodiment configured as described above prevents insufficient charging of the mobile terminal 20. The insufficient charging prevention process described below is a process of preventing the insufficient charging of the mobile terminal 20 caused by the user forgetting charging, and is executed in the vehicle 10.

First, the controller 11 acquires the remaining capacity of the mobile terminal 20 from the communication unit 12. Then, in the case where the remaining capacity of the mobile terminal 20 is equal to or less than the predetermined value, the controller 11 generates and outputs the information for displaying, on the display unit 16 or the operation/display unit 24, the fact that the mobile terminal 20 may be charged by the charger 14. As a result, in a case where the user does not notice the insufficient charging of the mobile terminal 20 or in a case where the user does not know that the mobile terminal 20 may be charged by the charger 14, the user is notified that the mobile terminal 20 may be charged, so that the insufficient charging of the mobile terminal 20 may be prevented. In particular, in a case where the user is a child and uses a GPS watching function of the mobile terminal 20, the insufficient charging of the mobile terminal 20 is prevented, so that the safety of the child may be ensured. Note that, in a case where the user is studying after getting in the vehicle, it is not necessary to notify the user that charging is possible.

In addition, the controller 11 may acquire a destination desired by the user from the input unit 15 or the operation/display unit 24, and generate and output information for displaying, on the display unit 16 or the operation/display unit 24, a capacity that is chargeable before the user reaches the destination. In this case, the user may know how much the mobile terminal 20 may be charged up to the destination. Note that the destination may be a destination input to the car navigation system of the vehicle 10, and in a case where the vehicle 10 is a bus, the destination may be estimated from a section of a commuter pass.

Furthermore, the controller 11 may generate and output information for displaying, on the display unit 16 or the operation/display unit 24, a location where the charger 14 is disposed. In a case where the vehicle 10 is a rental car or a vehicle rented in car sharing, the user may know the location where the charger 14 is disposed. In the case where the vehicle 10 is a bus, the user may know a location or a seat where the charger 14 capable of charging the mobile terminal 20 is disposed.

Furthermore, the controller 11 may acquire, from the input unit 15 or the operation/display unit 24, a selection result obtained by the user selecting one of a contact type charging method or a non-contact type charging method, and generate and output information for displaying, on the display unit 16 or the operation/display unit 24, a location where the charger 14 of the charging method according to the selection result is disposed. In this case, the user inputs the charging method of the mobile terminal 20 to the input unit 15 or the operation/display unit 24, so that it is possible to know the location of the charger 14 corresponding to the charging method of the mobile terminal 20. In particular, in a case where the vehicle 10 is a bus and there are a seat where the contact charger is disposed and a seat where the non-contact charger is disposed, the controller 11 causes the display unit 16 or the operation/display unit 24 to display a seat corresponding to the charging method of the mobile terminal 20, so that the user may charge the mobile terminal 20. Furthermore, in a case where the vehicle 10 is a bus and there is a seat where the mobile terminal 20 may be automatically charged when the user sits on the seat, a person who is likely to forget to charge the mobile terminal 20 may be preferentially guided to the seat.

Furthermore, in the case where the remaining capacity of the mobile terminal is equal to or less than the predetermined value, the controller 11 may generate and output information for displaying, on the display unit 16 or the operation/display unit 24, a location where the charger 14 capable of rapid charging is disposed. In particular, in a case where the vehicle 10 is a bus, there are a seat where the contact charger is disposed and a seat where the non-contact charger is disposed, and the mobile terminal 20 is compatible with both the charging methods of the contact charger and the non-contact charger, the controller 11 causes the display unit 16 or the operation/display unit 24 to display the seat where the contact charger, which is capable of rapid charging, is disposed, so that the user may charge the mobile terminal 20 more rapidly.

Furthermore, in a case where the server 30 is a server that manages an allocation system for allocating the vehicle 10 to a location based on a request of the user, the controller 31 may allocate, to the location based on the request of the user, the vehicle 10 including the charger 14 corresponding to the charging method of the mobile terminal 20. Note that allocation means moving the vehicle 10 to the location based on the request of the user. For example, the controller 31 controls the vehicle 10, which is an autonomous traveling vehicle, to automatically move the vehicle 10 to the location based on the request of the user. Furthermore, the controller 31 may cause the display unit 16 of the vehicle 10 to display the location based on the request of the user, so that the driver of the vehicle 10 may move the vehicle 10 to the location based on the request of the user. As a result, the user may charge the mobile terminal 20 with the charger 14, and may prevent the insufficient charging of the mobile terminal 20. In a case where the server 30 allocates the vehicle 10, which is a share-ride bus or taxi, the server 30 may allocate, to the location based on the request of the user, the vehicle 10 in which the charger 14 corresponding to the charging method of the mobile terminal 20 is not used by others and may be used by the user. Furthermore, in the case where the remaining capacity of the mobile terminal 20 is equal to or less than the predetermined value, the server 30 may allocate the vehicle 10 including the charger 14 capable of rapid charging to the location based on the request of the user.

Furthermore, the processing executed by any one of the controller 11 of the vehicle 10, the controller 21 of the mobile terminal 20, or the controller 31 of the server 30 may be executed by another controller.

In addition, the program to be executed by the vehicle 10 according to the embodiment may be provided by being recorded as file data in an installable format or an executable format in a computer-readable recording medium such as a CD-ROM, a flexible disk (FD), a CD-R, a digital versatile disk (DVD), a USB medium, or a flash memory.

Furthermore, the program to be executed by the vehicle 10 according to the embodiment may be stored on a computer connected to a network such as the Internet and provided by being downloaded via the network.

According to the present disclosure, it is possible to prevent insufficient charging of a mobile terminal.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control device comprising
a processor configured to:
acquire a remaining capacity of a mobile terminal; and
control a charger configured to charge the mobile terminal to charge the mobile terminal in a case where the remaining capacity of the mobile terminal is equal to or less than a predetermined value.

2. The control device according to claim 1, wherein the processor is configured to generate and output information for displaying, on a display, a fact that the charger is able to charge the mobile terminal.

3. The control device according to claim 1, wherein the processor is configured to:
acquire a destination of a user; and
generate and output information for displaying, on a display, a capacity that is chargeable before the user reaches the destination.

4. The control device according to claim 1, wherein the processor is configured to generate and output information for displaying, on a display, a location of the charger.

5. The control device according to claim 1, wherein the processor is configured to:
acquire a selection of a contact type charging method or a non-contact type charging method by the user; and
generate and output information for displaying, on a display, a location of the charger adapted to the selection.

6. The control device according to claim 1, wherein the processor is configured to generate and output information for displaying, on a display, a location where the charger adapted to rapid charging is disposed in the case where the remaining capacity of the mobile terminal is equal to or less than the predetermined value.

7. The control device according to claim 1, wherein the processor is configured to allocate a moving body including the charger to a location based on a request of a user.

8. A control system comprising:
a charger configured to charge a mobile terminal; and
a processor configured to
acquire a remaining capacity of the mobile terminal, and
control the charger to charge the mobile terminal in a case where the remaining capacity of the mobile terminal is equal to or less than a predetermined value.

9. The control system according to claim 8, wherein the processor is configured to generate and output information for displaying, on a display, a fact that the charger is able to charge the mobile terminal.

10. The control system according to claim 8, wherein the processor is configured to:
acquire a destination of a user; and
generate and output information for displaying, on a display, a capacity that is chargeable before the user reaches the destination.

11. The control system according to claim 8, wherein the processor is configured to generate and output information for displaying, on a display, a location of the charger.

12. The control system according to claim 8, wherein the processor is configured to:
acquire a selection of a contact type charging method or a non-contact type charging method by the user; and
generate and output information for displaying, on a display, a location of the charger adapted to the selection.

13. The control system according to claim 8, wherein the processor is configured to generate and output information for displaying, on a display, a location where the charger adapted to rapid charging is disposed in the case where the remaining capacity of the mobile terminal is equal to or less than the predetermined value.

14. The control system according to claim 8, wherein the processor is configured to allocate a moving body including the charger to a location based on a request of a user.

15. A non-transitory computer-readable recording medium on which an executable program is stored, the program causing a processor of a computer to execute:
acquiring a remaining capacity of a mobile terminal; and
controlling a charger configured to charge the mobile terminal to charge the mobile terminal in a case where the remaining capacity of the mobile terminal is equal to or less than a predetermined value.

16. The non-transitory computer-readable recording medium according to claim 15, wherein the program causes the processor to execute generating and outputting information for displaying, on a display, a fact that the charger is able to charge the mobile terminal.

17. The non-transitory computer-readable recording medium according to claim 15, wherein the program causes the processor to execute:
acquiring a destination of a user; and
generating and outputting information for displaying, on a display, a capacity that is chargeable before the user reaches the destination.

18. The non-transitory computer-readable recording medium according to claim 15, wherein the program causes the processor to execute generating and outputting information for displaying, on a display, a location of the charger.

19. The non-transitory computer-readable recording medium according to claim 15, wherein the program causes the processor to execute generating and outputting information for displaying, on a display, a location where the charger adapted to rapid charging is disposed in the case where the remaining capacity of the mobile terminal is equal to or less than the predetermined value.

20. The non-transitory computer-readable recording medium according to claim 15, wherein the program causes the processor to execute allocating a moving body including the charger to a location based on a request of a user.
